(19) United States
(12) Patent Application Publication
(10) Pub. No.: US 2005/0035133 A1
(43) Pub. Date: Feb. 17, 2005

(54) Method and apparatus for dispensing a sheet materials

(76) Inventors: Kristopher W. Gerulski, Racine, WI (US); Marissa A.K. Schultz, Racine, WI (US); John S. Sabol JR., Sanford, MI (US); John O. McCree, Bay City, MI (US); Robert R. Turvey, Sanford, MI (US); Nancy L. Broen, Racine, WI (US)

Correspondence Address: S.C. JOHNSON & SON, INC., 1525 HOWE STREET, RACINE, WI, 53403-2236, US

(21) Appl. No.: 10/857,155

(22) Filed: May 28, 2004

Related U.S. Application Data
(60) Provisional application No. 60/474,575, filed on May 29, 2003.
(60) Provisional application No. 60/477,507, filed on Jun. 10, 2003.
(60) Provisional application No. 60/503,430, filed on Sep. 16, 2003.

(51) Int. Cl. B65D 85/671; G07F 11/72; B65D 85/677; B65D 85/67; B65D 85/672; B26D 5/08; B65D 85/66; B65D 85/676; B65D 85/675

(52) U.S. Cl. 221/31; 83/614

(57) ABSTRACT

A dispenser for sheet material comprises a box including a lid section and a container section, wherein a portion of the lid section overlaps a panel of the container section. The dispenser further includes a slot formed in the portion of the lid section wherein the slot extends parallel to a longitudinal extent of the box. A track assembly is disposed on the portion of the lid section adjacent the slot and a slider is disposed on the track assembly, wherein the slider includes a cutting device extending toward an inside of the box.

### CROSS REFERENCE TO RELATED APPLICATIONS

This application claims the benefit of U.S. Provisional Application No. 60/474,575, filed May 29, 2003; U.S. Provisional Application No. 60/477,507, filed Jun. 10, 2003; and U.S. Provisional Application No. 60/503,430, filed Sep. 16, 2003.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to dispensers for sheet materials, and more particularly, to dispensers for storing and cutting sheet materials.

2. Description of the Background of the Invention

Sheet materials, such as plastic film, metal film and the like, are usually provided to the customer on a roll in a box. The box generally includes a strip of cutting teeth along an edge thereof. When a user desires to utilize a portion of sheet material, he must find the end of the roll, pull the film outwardly, and place the sheet material across the cutting teeth at a desired cutting location. Thereafter, the user must drag the sheet material across the cutting teeth, thereby cutting the sheet material. This process is tedious and rarely results in a uniform tear line across the sheet material.

Chen U.S. Pat. No. 4,787,284 discloses a cutting apparatus for wrap film. The apparatus includes a sliding saddle mounted in a sliding manner in a guiding track slot of a cardboard dispenser box. The sliding saddle includes a T-shaped upper half portion and an I-shaped lower half portion connected by a mid-prop. The I-shaped lower half portion is mounted on the guiding track slot such that the mid-prop and T-shaped upper half portion extend above the slot. The mid-prop includes a razor on a front portion thereof for cutting wrap film.

Chuang U.S. Pat. No. 4,960,022 discloses a plastic film cutter having a slidable cutting means is. The plastic film cutter includes rollers on a bottom surface thereof, wherein the rollers guide the cutter along a sliding furrow attached to a storage box containing a plastic film roll.

Schuler U.S. Pat. No. 6,105,481 discloses a foil dispenser for slicing and dispensing sections of foil. The dispenser includes a dispensing slot for dispensing foil therefrom and a cutting slot, wherein a cutting blade projects through the cutting slot. The cutting blade is situated on a blade holder, which is movable in a blade holder guide. When the dispenser is sufficiently inclined, the cutting blade moves under gravitational forces along the cutting slot to cut a portion of the foil from the roll.

Chen U.S. Pat. No. 6,223,639 discloses an aluminum foil safety fixture for separating aluminum foil in a safe and convenient cutting process. The fixture includes a supporting plate with a slide rail extending from a top edge of the supporting plate. The fixture further includes a push unit assembled in the slide rail, wherein the push unit includes at least one set of slide pressing rollers that keep the foil in a tense form during separation thereof.

Baker, Jr. U.S. Publication No. 2004/0007606 discloses a cutter for cutting sheet materials. The cutter includes a handle, a stem connected to the handle, a cutting blade, and optionally a hook attached to the stem for attaching the cutter to a box. The box includes a top surface, a front flap attached to the top surface, and a front wall, wherein a slot is formed between the front flap and the front wall. The handle straddles the slot such that the stem is disposed in the slot for guiding the cutter along the slot. If the cutter includes a hook, the hook is hooked around a bottom edge of the front flap to prevent the cutter from being removed from the box.

### SUMMARY OF THE INVENTION

According to one aspect of the present invention, a dispenser for sheet material comprises a box including a lid section and a container section, wherein a portion of the lid section overlaps a panel of the container section. The dispenser further includes a slot formed in the portion of the lid section wherein the slot extends parallel to a longitudinal extent of the box. A track assembly is disposed on the portion of the lid section adjacent the slot and a slider is disposed on the track assembly, wherein the slider includes a cutting device extending toward an inside of the box.

According to another aspect of the present invention, a dispenser for sheet material comprises a box including a lid section and a container section, wherein a portion of the lid section overlaps a panel of the container section and wherein the portion of the lid section and the panel of the container section form an angled corner. The dispenser further includes a cutting apparatus disposed on the angled corner.

Other aspects and advantages of the present invention will become apparent upon consideration of the following detailed description.

### BRIEF DESCRIPTION OF THE DRAWINGS

FIG. 1 is an isometric view of a dispenser according to a first embodiment;

FIG. 2 is a fragmentary isometric view of a portion of the dispenser shown in FIG. 1 in an open position;

FIG. 3 is an enlarged fragmentary sectional view taken generally along the lines 3-3 of FIG. 1;

FIG. 4 is an isometric view of a slider according to a first embodiment illustrating a bottom surface and blade thereon;

FIG. 4a is an isometric view similar to FIG. 4 illustrating a second embodiment;

FIG. 5 is sectional view taken generally along the lines 3-3 of FIG. 1;

FIG. 6 is an isometric view of a dispenser according to a third embodiment; and

FIG. 7 is an enlarged fragmentary sectional view taken generally along the lines 7-7 of FIG. 6.

### DETAILED DESCRIPTION OF THE PREFERRED EMBODIMENTS

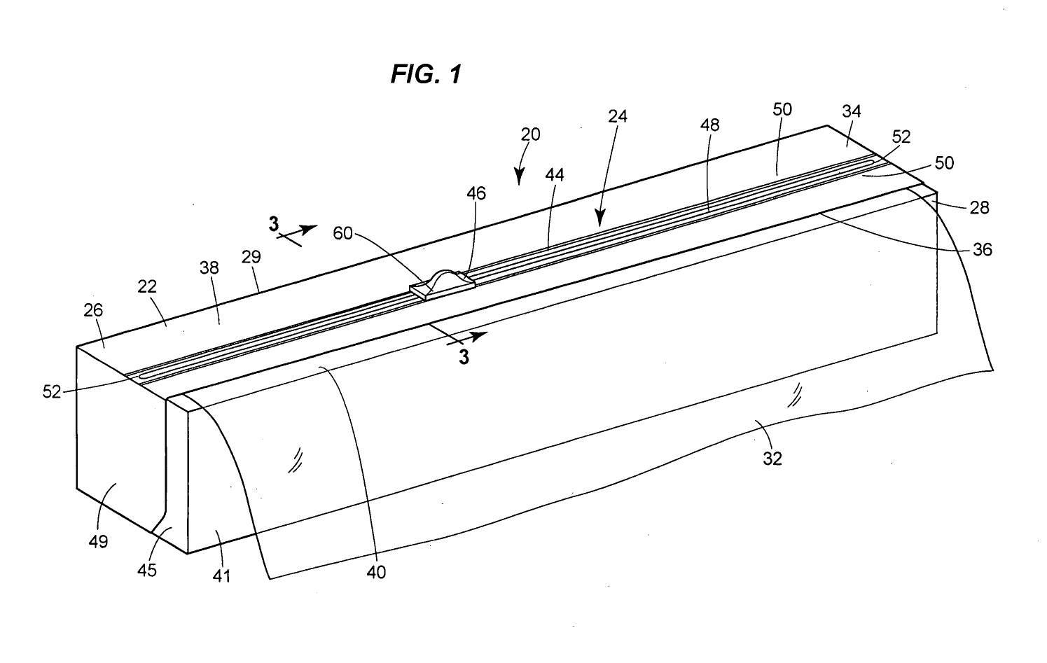

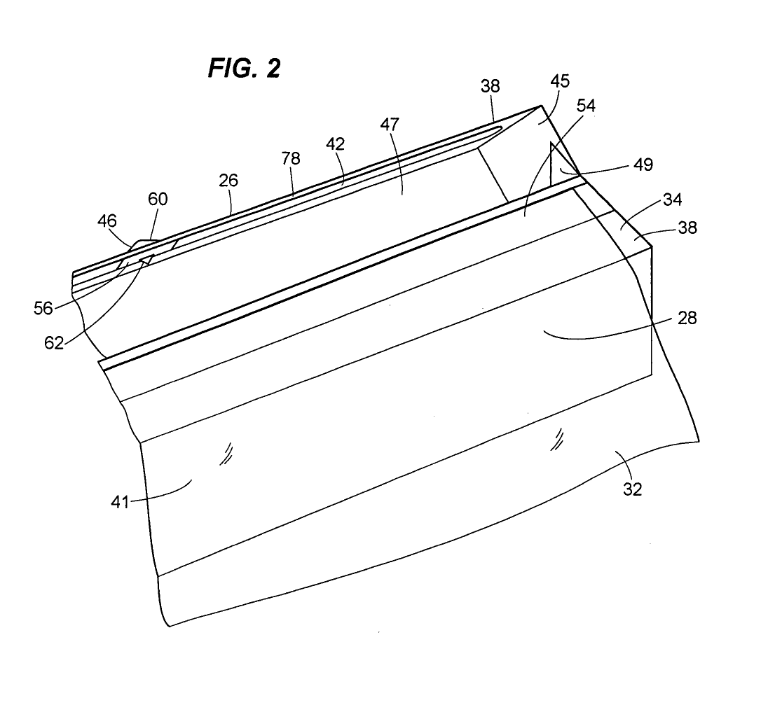

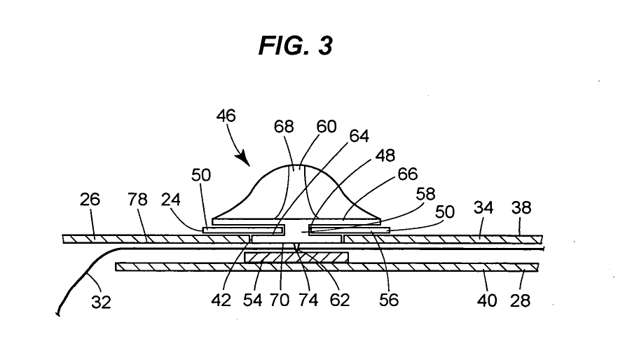

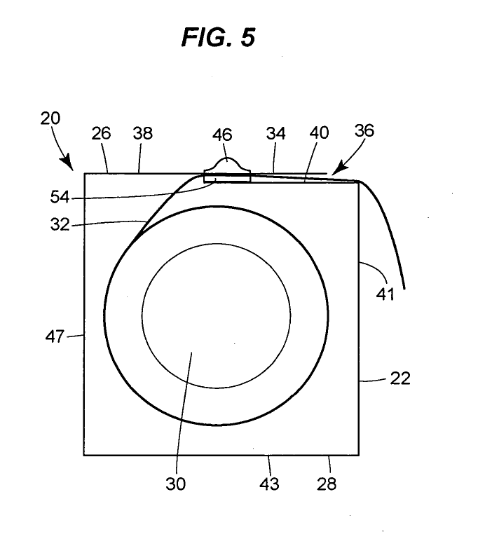

In the proceeding description reference numerals that differ only in the hundreds digit refer to like structures. An embodiment of a dispenser 20 is seen in FIGS. 1-5. The dispenser 20 comprises a box 22 and a cutting apparatus 24. The box 22 comprises a lid section 26 and a container section 28 integral with the lid section 26. A fold line 29 connects the lid section 26 and the container section 28 and acts as a hinge, or score thereby enabling the opening and closing of the lid section 26 with respect to the container section 28. FIG. 1 depicts the dispenser 20 in a closed position while FIG. 2 depicts the dispenser 20 in an open position. As seen in FIG. 5, a roll 30 of a thin sheet material 32, for example, a thermoplastic film, may be disposed within the box 22. A first side 34 of the box 22 includes an opening or mouth 36 formed between an edge of an overlapping portion, or flap, 38 of the lid section 26 and a first panel 40 of the container section 28. The container section 28 further comprises a second panel 41 adjacent the first panel and a third panel 43 adjacent the second panel 41 opposite the first panel 40. Each of two end panels 45 interconnect the first, second and third panels, 40, 41 and 43, at opposite ends. The lid section 26 further comprises a second portion 47 adjacent the overlapping portion 38 and interconnected to the third panel 43 of the container section 28 at the fold line 29 opposite the overlapping portion 38. Each of two end portions 49 interconnect the overlapping portion 38 and second portion 47 at opposite ends. Preferably, the overlapping portion 38 of the lid section 26 has a slot 42 formed therein, seen best in FIG. 3, extending substantially the width of the overlapping section 38 of the lid section 26 for accommodating the cutting apparatus 24 discussed in greater detail below. However, such a slot 42 could be formed in other portions or panels of the box including both the lid section 26 and the container section 28. Preferably, the box 22 is constructed of a cardboard or chipboard type material, however other materials could be utilized.

Furthermore, and as seen in FIG. 2, the box 22 preferably includes a cut resistant backing strip 54 that is disposed on the first panel 40 when the box 22 is in the closed position. The backing strip 54 can be attached to the box 22 in any manner known in the art, but preferably is attached utilizing an adhesive. If desired, although not necessarily, the backing strip 54 may be treated to attract the film 32 so that the material 32 is maintained in a flat condition. This treatment may comprise application of a low-tack adhesive, electrostatic charging, or the like. It should be noted that while a specific example of a box is described, the use of other types of boxes adapted to dispense a film may also be used without departing from the spirit of the invention.

The roll 30 of film 32 is preferably mounted in the container section 28 of the box 22 using any method known in the art (e.g., the roll may be journaled in the container section 28) so that the film 32 can be pulled from the box 22 as a thin flat sheet without pulling the entire roll 30 from the container. Alternatively, the roll 30 may be loose (i.e. not journaled or otherwise restrained) within the container section 28, in which case the film 32 can be withdrawn from the box 22 with the lid section 26 substantially in the closed position so that the roll 30 is retained in the box 22. As a still further alternative, the film 32 may be pulled from the box 22 with the lid section 26 partially or completely open, in which case the user should take care to restrain the roll 30 so that the roll 30 is not pulled from the box 22.

The cutting apparatus 24 includes a track assembly 44 and a slider 46. The track assembly 44 is preferably, but not necessarily, made of thermoplastic and defines a channel 48 that is preferably of smaller lateral dimension (i.e. left to right as seen in FIG. 3) than the slot 42. The track assembly 44 typically extends the length of the box 22 and is slightly or substantially longer than the width dimension of the film 32. The channel 48 is defined by a pair of elongate portions 50 disposed parallel with the mouth 36 and a pair of end portions 52 disposed at either end of the elongate portions 50 and connecting the elongate portions 50 together. As shown in FIG. 3, the track assembly 44 is preferably disposed on the box 22 such that the pair of elongate portions 50 partially covers the lid section 26 and partially covers the slot 42 such that the channel 48 is disposed in a centered relationship over the slot 42. However, in another embodiment (not shown) the channel may be of size and dimension equal to or larger than the lateral dimension of the slot, whereby the track assembly could be disposed on the box such that the elongate portions only cover the lid section and not the slot. The cutting apparatus further includes means for attachment (not shown) to the box 22. In a preferred embodiment such means includes an adhesive backing on the sides of the elongate portions 50 that are in contact with the lid section 26; however, other attaching means including tacks, staples, or the like may be employed. In another embodiment (not shown), the track assembly 44 may be integrally formed with the box 22, thus eliminating the need for an attachment means.

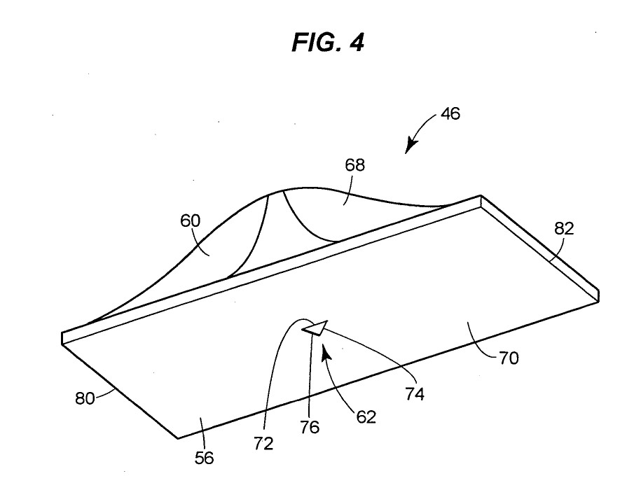

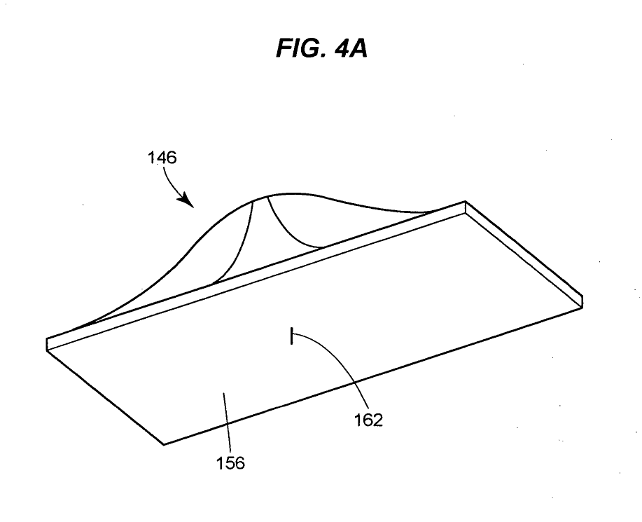

The slider 46 operates in conjunction with the track assembly 44 and includes a base 56, a neck 58, a head 60, and a blade 62 as seen in FIGS. 3 and 4. In a preferred embodiment, the base 56 is of size and dimension to fit within the slot 42 but cannot pass outwardly through the channel 48. Further, the base 56 preferably, but not necessarily, does not extend substantially below an inner surface 78 of the overlapping portion 38 of the lid section 26 where the base 56 could interfere with the cutting operation described below. The neck 58 extends outwardly from a first side 64 of the base 56 and is of size and dimension to fit within the channel 48. Preferably, although not necessarily, the neck 58 extends the entire length of the base 56 i.e., from a first end 80 to a second end 82 of the base 56 as seen in FIG. 4. However, in the embodiment described above wherein the channel is equal to or larger than the slot, the neck and base of the slider may vary. In such an embodiment the base is of size and dimension that it cannot pass through the slot or the channel. The base is disposed below the inner surface 78 of the overlapping portion 38. The neck extends outwardly from the first side of the base and is of size and dimension to fit within both the channel and the slot. The head 60 extends outwardly from the neck 58 opposite the base 56 and is preferably of size and dimension larger than the channel 48. While a preferred shape of the head 60 is seen best in FIGS. 1 and 3, the head 60 may take any shape. The preferred shape includes a flat bottom portion 66 connected to the neck 58 and a contoured upper portion 68 extending away from the neck 58 and shaped to receive a user's fingers. As seen particularly in FIG. 4, the blade 62 extends inwardly from a second side 70 of the base 56 opposite the first side 64 and thus extends below the inner surface of the overlapping portion 38 of lid section 26 of the box 22. The blade 62 preferably including first and second cutting edges 74, 76. The blade 62 is attached to the base 56 by any suitable means or method. For example, the blade 62 may be molded into the base 56 or may be secured in a slot (not shown) by an adhesive or one or more fasteners.

In other embodiments the blade may take a different form such as a pin blade 162 as shown in FIG. 4a. The pin blade 162 is a simple spike extending from the base 156 of the slider 146; however, any style of blade capable of piercing the film 32 as described below may be utilized. Preferably, the blade is made of metal, however, other materials, such as plastic or ceramic, may be utilized. The remainder of the slider 46 is preferably molded as a single piece of thermoplastic, and in an embodiment utilizing a plastic blade the entire slider 46 may be molded as a single piece. However, multi-piece designs may also be utilized regardless of the type of blade employed.

In operation, the user pulls the desired length of film 32 from the roll 30 and out of the open box 22 via the mouth 36, as seen best in FIGS. 2 and 5. The sheet 32 is then laid on the cut resistant backing strip 54 and the box 22. Preferably, although not necessarily, the slider 46 is first moved into contact with one of the two end portions 52 of the track assembly 44, the lid section 26 is moved to the closed position, and the slider is moved into contact with the other of the two end portions 52 to sever the film 32. Alternatively, the slider 46 may be positioned intermediate the end portions 52 and the lid section 26 may be moved to the closed position. The slider is then moved into contact with a first end portion 52 and then moved into contact with the other end portion 52 to sever the film 32. With the box 22 in the closed position the blade 62 comes in contact with the sheet 32 as seen in FIG. 3. The user then applies pressure to the head 60 of the slider 46 and the blade 62 is pressed through the film 32, thereby piercing the film 32 and pressing the blade 62 into the cut resistant backing strip 54. Alternatively, it should be noted that the blade 62 may pierce the film 32 simply during the process of moving the box 22 into the closed position. The user then moves the slider 46 along the track assembly 44 first into contact with one of the end portions 52 and thereafter to the other of the end portions 52, thereby moving the blade 62 through the width of the film 32 and severing a section of the film 32 from the roll 30. The severed section of film 32 is then removed. As should be evident from the forgoing, the first and second cutting edges 74, 76 enable the cutting apparatus 24 to cut the film 32 when the slider 46 is moved in either of two directions.

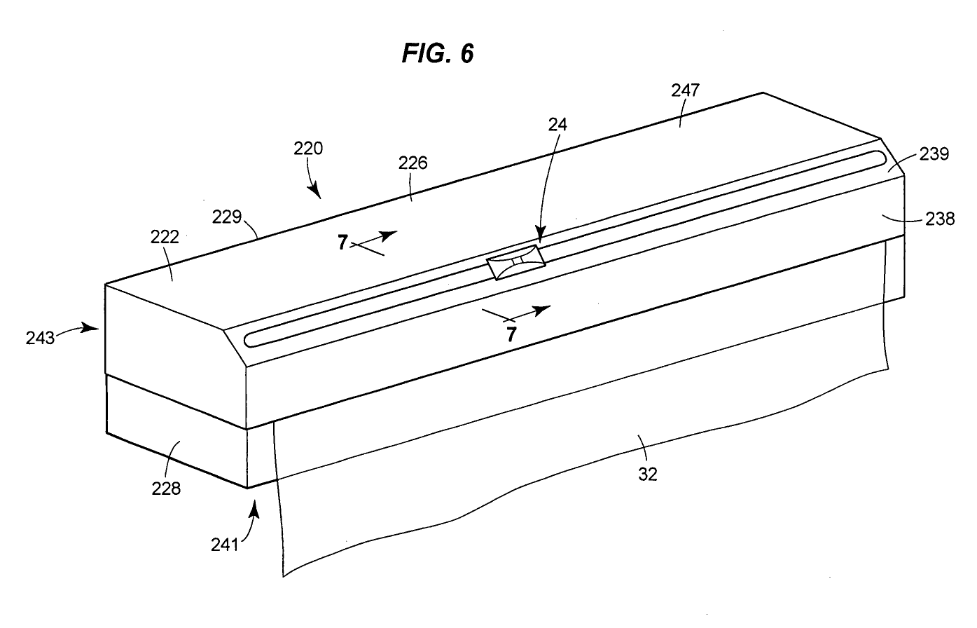

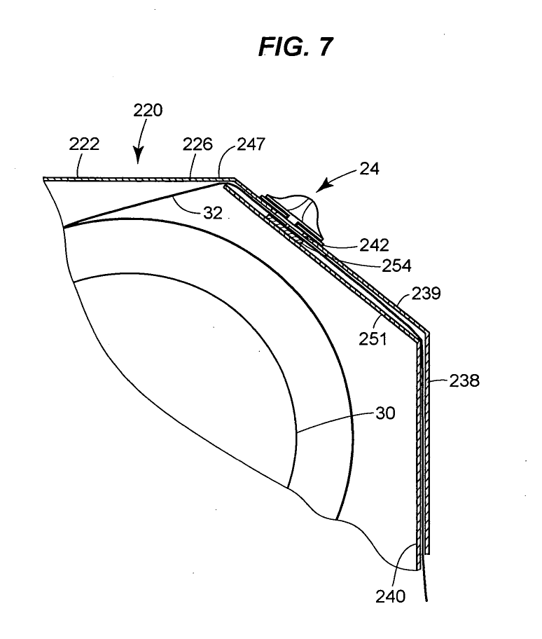

An alternative embodiment of a dispenser 220 is seen in FIGS. 6 and 7. The cutting apparatus 24 is identical to the one described above, however, the box 222 and location of the cutting apparatus 24 differ. The box 222 includes a lid section 226 and a container section 228. A fold line 229 connects the lid section 226 and the container section 228 and acts as a hinge thereby enabling the opening and closing of the lid section 226 with respect to the container section 228. The box 222 is shown in a closed position in FIGS. 6 and 7. The lid section 226 includes an overlapping portion 238 and second portion 247 connected by an angled portion 239. Each of two end portions interconnect the overlapping portion 238, the second portion 247 and the angled portion 239 at opposite ends. Preferably, the angled section 239 of the lid section 226 has a slot 242 extending substantially the width of the first angled section 239 of the lid section 226 for accommodating the cutting apparatus 24. The container section 228 includes an angled panel 251 connected to a first panel 240 of the container section 228. A second panel 241 is adjacent the first panel 240 opposite the angled panel 251; and a third panel 243 is adjacent the second panel 241 opposite the first panel 240. Each of two end panels 245 interconnect the angled panel 251, first panel 240, second panel and third panel 243 at opposite ends. A cut resistant backing strip 254 is also included that is attached to the second angled section 241 and disposed opposite the slot when the box 22 is in the closed position, as shown in FIG. 7. If desired, although not necessarily, the backing strip 54 may be treated to attract the film 32 so that the material 32 is maintained in a flat condition. This treatment may comprise application of a low-tack adhesive, electrostatic charging, or the like. It should be noted that while a specific example of a box is described, the use of other types of boxes adapted to dispense a film may also be used without departing from the spirit of the invention. A first side 234 of the box 222 includes an opening or mouth 236 formed at an edge of the overlap between the overlapping section 238 of the lid section 226 and a first panel 240 of the container section 228. A roll 30 of a film 32, such as a thermoplastic film, is disposed in an identical manner to the roll in relation to the first embodiment of a dispenser described above.

A cutting apparatus 24 identical to the apparatus described in relation to the first embodiment of a dispenser 20 above may be utilized in this embodiment. The cutting apparatus 24 is attached to the first angled section 239 around the slot 242 in an identical manner as the cutting apparatus 24 was attached to lid section 26 in the first embodiment of a dispenser 20 described above. Therefore, in operation the film 32 is pulled from the roll, over the second angled section 241 and backing strip 254 of the container section 228, and over the first panel 240 of the container section 228 to the desired length. The lid portion 226 is then moved into closed position seen in FIGS. 6 and 7, whereby the first angled section 239 and second angled section 241 are aligned and the cutting apparatus 24 covers the backing strip 254 and the blade 62 may pierce the film 32 as described above. The remaining operation is identical to the operation of the first embodiment.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. A dispenser for sheet material, comprising:
a box including a lid section and a container section, wherein a portion of the lid section overlaps a panel of the container section;
a slot formed in the portion of the lid section wherein the slot extends parallel to a longitudinal extent of the box;
a track assembly disposed on the portion of the lid section adjacent the slot; and
a slider disposed on the track assembly, the slider including a cutting device extending toward an inside of the box.

2. The dispenser of claim 1, wherein the track assembly further covers a portion of the slot and includes a portion defining a channel therethrough that has a width smaller than a width of the slot.

3. The dispenser of claim 2, wherein the slider includes a base portion disposed in the slot and having a width greater than a width of the channel.

4. The dispenser of claim 3, wherein the slider further includes a neck portion extending from the base portion and disposed in the channel.

5. The dispenser of claim 4, wherein the slider further includes a head portion extending from the neck portion and having a width greater than the channel to restrict movement of the slider in a direction transverse to a direction of movement of the slider.

6. The dispenser of claim 5, wherein the cutting device protrudes from a bottom surface of the base.

7. The dispenser of claim 6, wherein the cutting device is a blade.

8. The dispenser of claim 6, wherein the cutting device is a pin blade.

9. The dispenser of claim 6, wherein an outer side of the panel of the container section disposed adjacent the slot includes a backing strip that extends parallel to the slot and the channel.

10. The dispenser of claim 9, wherein the backing strip has an electrostatic charge to attract film so the film is maintained in a flat condition.

11. The dispenser of claim 9, wherein the panel of the container section covered by the overlapping portion and the overlapping portion are angled.

12. A dispenser for sheet material, comprising:
a box including a lid section and a container section, wherein a portion of the lid section overlaps a panel of the container section and wherein the portion of the lid section and the panel of the container section form an angled corner; and
a cutting apparatus disposed on the angled corner.

13. The dispenser of claim 12, wherein a slot is formed in the portion of the lid section and wherein the slot extends parallel to a longitudinal extent of the box.

14. The dispenser of claim 13, wherein the cutting apparatus includes a track assembly disposed on the portion of the lid section adjacent the slot and further covering a portion of the slot.

15. The dispenser of claim 14, wherein the cutting apparatus further includes a slider disposed on the track assembly, the slider including a cutting device extending toward an inside of the box.

16. The dispenser of claim 15, wherein the track assembly includes a portion defining a channel therethrough that has a width smaller than a width of the slot.

17. The dispenser of claim 16, wherein the slider includes a base portion disposed in the slot and having a width greater than a width of the channel.

18. The dispenser of claim 17, wherein the slider further includes a neck portion extending from the base portion and disposed in the channel.

19. The dispenser of claim 18, wherein the slider further includes a head portion extending from the neck portion and having a width greater than the channel to restrict movement of the slider in a direction transverse to a direction of movement of the slider.

20. The dispenser of claim 19, wherein the cutting device protrudes from a bottom surface of the base.

21. The dispenser of claim 20, wherein the cutting device is a blade.

22. The dispenser of claim 20, wherein the cutting device is a pin blade.

23. The dispenser of claim 20, wherein an outer side of the panel of the container section disposed adjacent the slot includes a backing strip that extends parallel to the slot and the channel.

24. The dispenser of claim 23, wherein the back strip has an electrostatic charge to attract film so the film is maintained in a flat condition.
